(19) United States
(12) Patent Application Publication
(10) Pub. No.: US 2012/0155140 A1
(43) Pub. Date: Jun. 21, 2012

(54) Asynchronous Sigma-Delta Modulation Controller

(75) Inventors: Yaow-Ming Chen, Taoyuan County (TW); Chia-Hsi Chang, Taoyuan County (TW); Zen-Shan Chang, Taoyuan County (TW); Kuo-Kuang Jen, Taoyuan County (TW); Yu-Min Liao, Taipei County (TW)

(73) Assignee: Chung-Shan Institute of Science and Technology, Armaments, Bureau, Ministry of National Defense, Taoyuan County (TW)

(21) Appl. No.: 12/973,948

(22) Filed: Dec. 21, 2010

(51) Int. Cl. H02M 7/5387

(52) U.S. Cl. 363/132

(57) ABSTRACT

A constant-frequency asynchronous modulation apparatus includes a current feedback control unit connected to a constant-frequency asynchronous modulation unit. The current feedback control unit includes a reference signal generator and an error amplifier. The reference signal generator provides an error. The error amplifier is connected to a reference signal generator, and provides an error-compensating signal based on the error, and adds up a reference signal and the error-compensating signal to provide a compensation reference signal. The constant-frequency asynchronous modulation unit connected to the current feedback control unit, and includes a hysteresis comparator, an integrator connected to the hysteresis comparator, and a hysteresis boundary generator connected to both of the hysteresis comparator and the integrator. The hysteresis boundary generator provides a power source voltage, a time constant for the integrator, a switching frequency and a real-time reference signal so that a hysteresis boundary changes as the reference signal changes.

### BACKGROUND OF INVENTION

1. Field of Invention

The present invention relates to an asynchronous sigma-delta modulation and, more particularly, to current control for use in a grid-tied converter to control the current of the grid-tied converter to simplify the design of the filter and compensator of the converter so that simple digital signal micro processor can be used to control the grid-tied converter.

2. Related Prior Art

Typical current control in single-phase voltage-source grid-tied converters is classified into three types: hysteresis current control, ramp-comparing current control method and predicative current control. Asynchronous sigma-delta modulation current control belongs to hysteresis current-control. Asynchronous sigma-delta modulation current control involves a simple circuit, and is easily under control, and entails little electromagnetic interference. Hence, asynchronous sigma-delta modulation current control is suitable for use in a grid-tied converter.

Asynchronous sigma-delta modulation is developed from synchronous sigma-delta modulation. It involves a circuit consisting of an integrator and a comparator. The comparator includes a sample-and-hold circuit for judging state-changing actions of a pulse signal provided by the comparator. The sample-and-hold circuit has to regularly sample clock. Hence, it is called the “synchronous sigma-delta modulation.” In early days, the synchronous sigma-delta modulation was used in analog/digital converters because it excellently resisted noise. Recently, it has been used in energy converters and incurs only a small amount of harmonic waves and little electromagnetic interference.

However, the synchronous sigma-delta modulation needs a synchronous clock source and cannot easily be realized in an analog circuit. To simplify a circuit for realizing the sigma-delta modulation and reduce the cost of the circuit, the asynchronous sigma-delta modulation is developed. A circuit for realizing the asynchronous sigma-delta modulation includes a hysteresis comparator instead of the comparator and sample-and-hold circuit of the circuit for realizing the synchronous sigma-delta modulation. That is, the circuit for realizing the asynchronous sigma-delta modulation includes the integrator and the hysteresis comparator. A reference signal is compared with the hysteresis boundary of the hysteresis comparator to determine the state of the pulse signal. There is no need for a synchronous clock source. Hence, this type of sigma-delta modulation is called the “asynchronous modulation.” The pulse signal is fed back and differentiated with the reference signal to achieve an error signal. The error signal is handled by the integrator before it is handled by the hysteresis comparator, thus providing a control signal for a power switch for regulating in output current from an energy converter.

Alternatively, variable-frequency sigma-delta control can be used to control the grid-tied converter and incurs only a small amount of harmonic waves and little electromagnetic interference. However, there is uneven distribution of noise in a power switch during the variable-frequency switching and complicates an output filter and current-controlling compensator of an energy converter. Moreover, if a digital signal processor is used to realize the asynchronous sigma-delta modulation, extra time is required to calculate the switching frequency that changes in every cycle, and the current response of the energy converter is reduced.

Therefore, the present invention is intended to obviate or at least alleviate the problems encountered in prior art.

### SUMMARY OF INVENTION

It is the primary objective of the present invention to provide a constant-frequency asynchronous modulation apparatus to control the current of the grid-tied converter to simplify the design of the filter and compensator of the converter so that simple digital signal micro processor can be used to control the grid-tied converter.

To achieve the foregoing objective, the constant-frequency asynchronous modulation apparatus includes a current feedback control unit connected to a constant-frequency asynchronous modulation unit. The current feedback control unit includes a reference signal generator and an error amplifier. The reference signal generator provides an error. The error amplifier is connected to a reference signal generator, and provides an error-compensating signal based on the error, and adds up a reference signal and the error-compensating signal to provide a compensation reference signal. The constant-frequency asynchronous modulation unit connected to the current feedback control unit, and includes a hysteresis comparator, an integrator connected to the hysteresis comparator, and a hysteresis boundary generator connected to both of the hysteresis comparator and the integrator. The hysteresis boundary generator provides a power source voltage, a time constant for the integrator, a switching frequency and a real-time reference signal so that a hysteresis boundary changes as the reference signal changes.

The constant-frequency asynchronous modulation apparatus may further includes a solar cell array, a boost DC/DC converter connected to the solar cell array, a grid-tied inverter connected to the boost DC/DC converter and the constant-frequency asynchronous modulation unit, and a grid connected to the grid-tied inverter.

In an aspect, the boost DC/DC converter includes a switch, a resistor, a diode and a DC-link capacitor that are connected to one another. The DC-link capacitor is connected to the grid so that stable DC electricity is boosted and converted to a stable DC-link voltage to be provided to the grid.

In a further aspect, the grid-tied inverter includes four switches connected to one another. The grid-tied inverter converts the DC-link voltage to a sine output current to be incorporated in the grid, and regulates the output current based on the DC-link voltage.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a block diagram of an asynchronous modulation apparatus according to the preferred embodiment of the present invention;

FIG. 2 shows waveforms of various signals provided by the asynchronous modulation apparatus;

FIG. 3 shows details of the waveforms of the signals shown in FIG. 2;

FIG. 4 is a chart of the voltage versus a first current handled by the asynchronous modulation apparatus shown in FIG. 1; and

FIG. 5 is a chart of the voltage versus a second current handled by the asynchronous modulation apparatus shown in FIG. 1.

### DETAILED DESCRIPTION OF PREFERRED EMBODIMENT

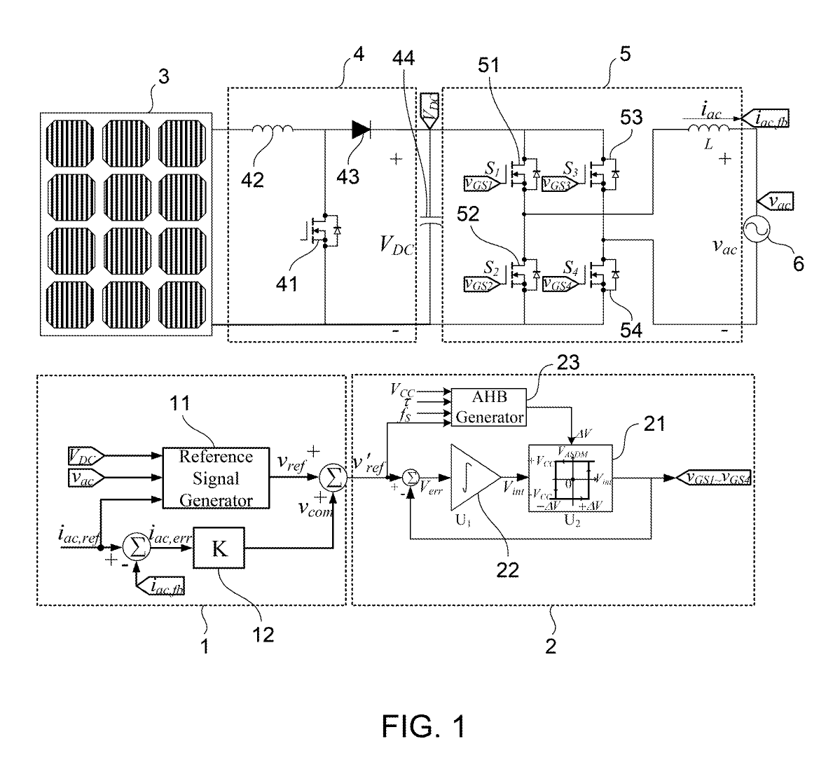

Referring to FIG. 1, an asynchronous modulation apparatus includes a current feedback control unit 1 connected to a constant-frequency asynchronous modulation unit 2 according to the preferred embodiment of the present invention. The current feedback control unit 1 includes a reference signal generator 11 connected to an error amplifier 12.

The constant-frequency asynchronous modulation unit 2 includes a hysteresis comparator 21, an integrator 22 connected to the hysteresis comparator 21, and a hysteresis boundary generator 23 connected to both of the hysteresis comparator 21 and the integrator 22.

The asynchronous modulation apparatus can be used with a solar cell array 3, a boost DC/DC converter 4, a grid-tied inverter 5 and a grid 6. The grid-tied inverter 5 is connected to the grid 6 on one hand and connected to the constant-frequency asynchronous modulation unit 2 on the other hand. The boost DC/DC converter 4 is connected to the grid-tied inverter 5. The solar cell array 3 is connected to the boost DC/DC converter 4. The boost DC/DC converter 4 includes a switch 41, a resistor 42, a diode 43 and a DC-link capacitor 44 that are connected to one another. The grid-tied inverter 5 includes four switches 51, 52, 53 and 54 connected to one another.

In operation, the solar cell array 3 converts solar energy into DC electricity. If the DC electricity generated by the solar cell array 3 fluctuates as luminance, and/or temperature change, the boost DC/DC converter 4 boosts the unstable electricity. Then, the DC-link capacitor 44 is use to provide a stable DC-link voltage V_{DC} based on the boosted unstable electricity. Furthermore, the boost DC/DC converter 4 must provide a maximum power-tracking ability so that the voltage and current of the electricity generated by the solar cell array 3 can be regulated to provide the optimal generation efficiency.

The grid-tied inverter 5 converts the DC-link voltage V_{DC} to a sine wave output current i_{ac} and incorporates the sine wave output current i_{ac} into the voltage v_{ac} of the grid 6. Furthermore, the grid-tied inverter 5 regulates the sine output current i_{ac} based on the DC-link voltage V_{DC}.

When the electricity generated by the solar cell panel 3 is larger than the energy incorporated in the voltage V_{ac} of the grid 6, the DC-link voltage V_{DC} will increase. Hence, the current i_{ac} incorporated in the voltage v_{ac} of the grid 6 must increase too. On the contrary, when the electricity generated by the solar cell panel 3 is smaller than the energy incorporated in the voltage v_{ac} of the grid 6, the DC-link voltage V_{DC} will decrease. Hence, the current i_{ac} incorporated in the voltage v_{ac} of the grid 6 must decrease too. In a stable state, the DC-link voltage is controlled to be constant to achieve balance between the input and output powers of a photovoltaic system.

A reference signal V_{ref} is provided by the reference signal generator 11 of the current feedback control unit 1 based on converter feedback parameters V_{DC,fb} and V_{ac,fb} and a reference current i_{ac,ref}. The reference signal v_{ref} is compared with an actual output current i_{ac,fb} provided by a feedback inverter, thus providing an error signal i_{ac,err}. Based on the error signal, an error-compensating signal v_{com} is provided by the error amplifier 12. The reference signal and the error-compensating signal are added up, thus providing a compensation reference signal V′_{ref}. Thus, gate control signals v_{GS1}, v_{GS2}, v_{GS3} and v_{GS4} for the switches 51, 52, 53 and 54 are provided. By switching the signals of the switches, an expected converter output current i_{ac} is provided.

The hysteresis boundary generator 23 of the constant-frequency asynchronous sigma-delta modulation unit 2 provides circuit-related parameters including a power source voltage V_{CC} of a calculation amplifier, a time constant of an integrator, a switching frequency fₛ and an real-time input reference signal V′_{ref}. The reference signal for controlling the current of the grid-tied inverter 5 is a sine wave function. Therefore, an adaptive hysteresis boundary is also a sine wave. When the reference signal is large, the hysteresis boundary is small. On the contrary, when the reference signal is small, the hysteresis boundary is large. Hence, regardless of the reference signal, the control unit provides pulse signals at a constant frequency identical to a predetermined value.

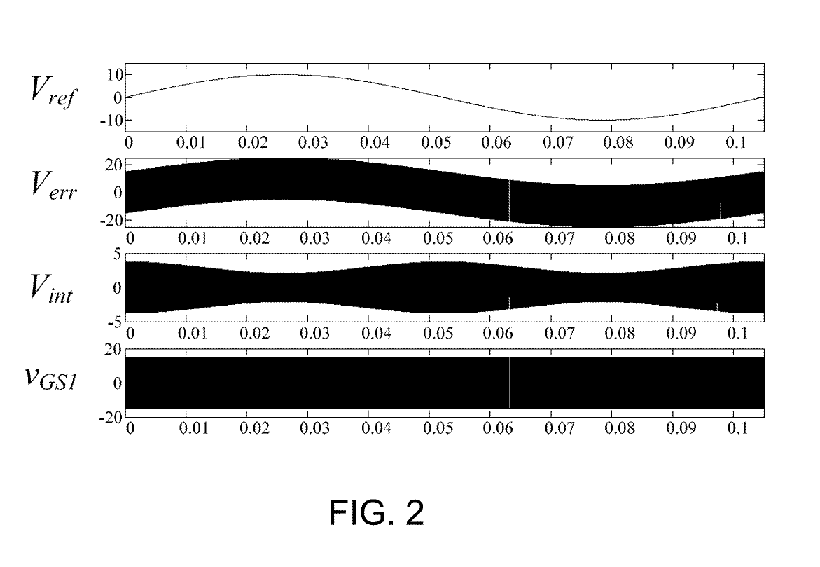

Referring to FIG. 2, the waveforms of the various signals are shown. From FIG. 2, it can be learned that the hysteresis comparator includes an adaptive hysteresis boundary. The magnitude of the adaptive hysteresis boundary is inversely proportional to the amplitude of the reference signal.

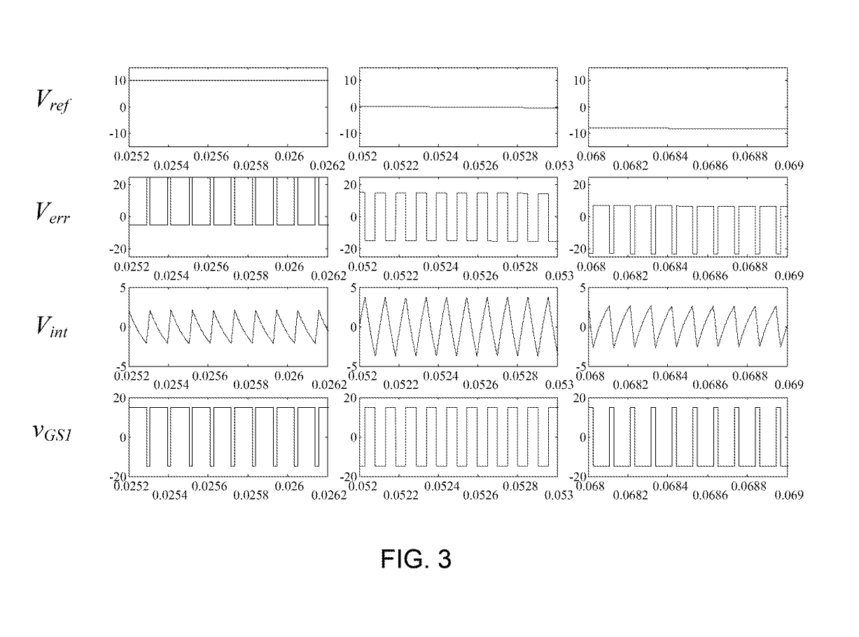

Referring to FIG. 3, details of the waveforms of the various signals shown in FIG. 2 are given. Three sections of the waveform of each of the signals are extracted where the signal is positive, zero an negative. From FIG. 3, it is learned that the operative period of the output pulse signal provided by the controller is linearly proportion to the reference signal. The magnitude of the hysteresis boundary changes as the value of the reference signal changes. Hence, regardless of the magnitude of the reference signal, the output pulse signal is provided at a constant frequency.

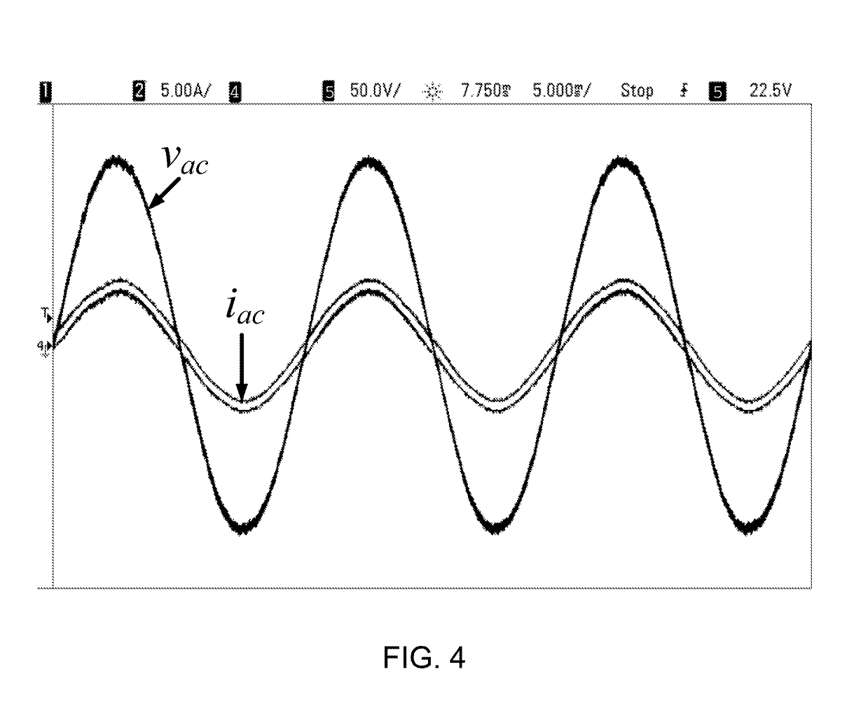

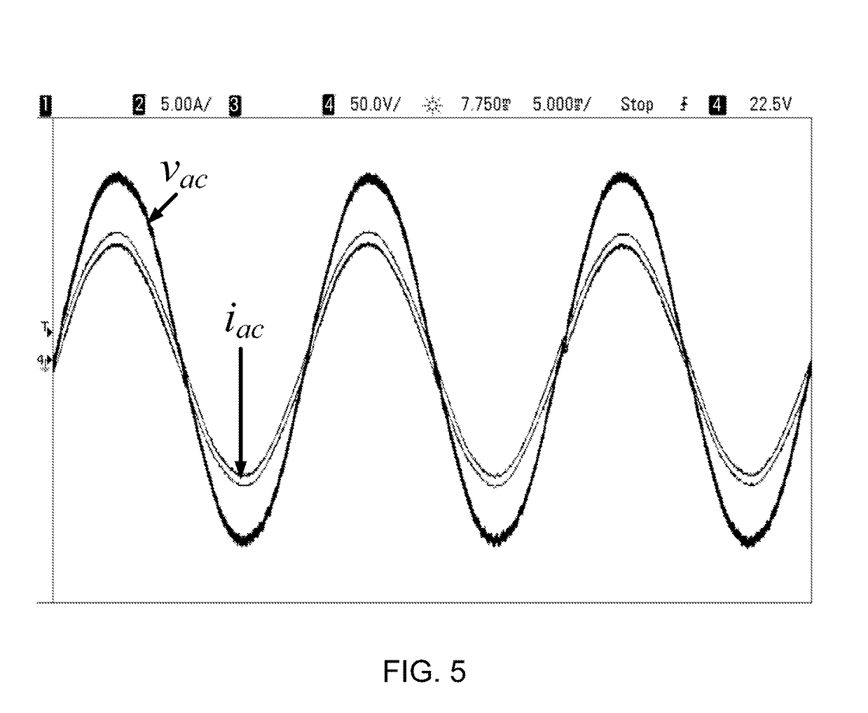

Referring to FIG. 4, the amplitude of the current is 5 amperes. Referring to FIG. 5, the amplitude of the current is 10 amperes. From FIGS. 4 and 5, it can be learned that the power factor of the current and voltage of the grid 6 is very close to 1. Furthermore, the current includes only a small amount of harmonic-wave components.

As discussed above, the constant-frequency asynchronous sigma-delta modulation apparatus can effectively reduce the drawbacks addressed in the Related Prior Art. The constant-frequency asynchronous sigma-delta modulation apparatus can be used to control the current of the grid-tied converter to simplify the design of the filter and compensator of the converter, and simple digital signal micro processor can be used to control the grid-tied converter.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A constant-frequency asynchronous modulation apparatus including:
a current feedback control unit 1 including:
a reference signal generator 11 for providing an error; and
an error amplifier 12 connected to a reference signal generator 11 for providing an error-compensating signal based on the error and adding up a reference signal and the error-compensating signal to provide a compensation reference signal; and
a constant-frequency asynchronous modulation unit 2 connected to the current feedback control unit 1 and formed with:
a hysteresis comparator 21;
an integrator 22 connected to the hysteresis comparator 21; and
a hysteresis boundary generator 23 connected to both of the hysteresis comparator 21 and the integrator 22 for providing a power source voltage, a time constant for the integrator, a switching frequency and a real-time reference signal so that a hysteresis boundary changes as the reference signal changes.

2. The constant-frequency asynchronous modulation apparatus according to claim 1, further including:
a solar cell array 3;
a boost DC/DC converter 4 connected to the solar cell array 3;
a grid-tied inverter 5 connected to the boost DC/DC converter 4 and the constant-frequency asynchronous modulation unit 2; and
a grid 6 connected to the grid-tied inverter 5.

3. The constant-frequency asynchronous modulation apparatus according to claim 2, wherein the boost DC/DC converter 4 includes a switch 41, a resistor 42, a diode 43 and a DC-link capacitor 44 that are connected to one another, wherein the DC-link capacitor 44 is connected to the grid 6 so that stable DC electricity is boosted and converted to a stable DC-link voltage to be provided to the grid 6.

4. The constant-frequency asynchronous modulation apparatus according to claim 3, wherein the grid-tied inverter 5 includes four switches 51, 52, 53 and 54 connected to one another, wherein the grid-tied inverter 5 converts the DC-link voltage to a sine output current to be incorporated in the grid 6, and regulates the output current based on the DC-link voltage.
